(19) United States
(12) Patent Application Publication
(10) Pub. No.: US 2026/0331765 A1
(43) Pub. Date: Oct. 22, 2026

(54) ADAPTIVE DIFFERENTIAL EVOLUTION TECHNIQUES FOR ANTENNA POSITION OPTIMIZATION IN WIRELESS NETWORKS

(71) Applicant: City University of Hong Kong, Kowloon (HK)

(72) Inventors: Yunpu Zhang, Kowloon City (HK); Hing Cheung So, Kowloon (HK)

(21) Appl. No.: 19/181,187

(22) Filed: Apr. 16, 2025

(51) Int. Cl. H01Q 3/02; H01Q 1/52; H04B 17/27

(52) U.S. Cl. CPC H01Q 3/02; H01Q 1/521; H04B 17/27

(57) ABSTRACT

This disclosure provides systems, methods, and devices that optimize antenna positioning in wireless communication systems. In one aspect, a method is provided that includes determining first data corresponding to positions of a subset of antennas in a wireless communication system, determining second data corresponding to target positions for the antennas by applying an iterative evolutionary process to the first data, and adjusting the physical positions of the antennas based on the determined target positions. The iterative evolutionary process may represent each antenna position as an individual within the process, and may specifically implement a differential evolution process. Other aspects are provided

### TECHNICAL FIELD

The present disclosure relates to wireless communication systems and, more particularly, to methods and systems for optimizing positions of movable antennas used in wireless communication systems.

### BACKGROUND

The use of radio frequency (RF) signals, such as for providing wireless communication of voice, images, and data, for use in imaging, to provide sensing, etc., is commonplace to the point of nearly becoming ubiquitous. An antenna is an indispensable component of any RF radiating system to radiate out the signal generated from the signal sources or transmitters and of any RF receiving system to provide a signal to the receivers or signal sink from a radiated signal impinging on the antenna. Wireless communication systems rely on antennas to transmit and receive electromagnetic waves, enabling devices to communicate without physical connections. Traditional antennas are typically fixed in position, which may limit their ability to adapt to changing environmental conditions and user demands. Advances in antenna technology have introduced movable antennas, which can adjust their positions within a designated area or space. Movable antennas offer the potential for improved signal quality, enhanced coverage, and increased capacity in wireless networks by dynamically optimizing their positions in response to real-time conditions.

### SUMMARY

The present disclosure relates to improved techniques for optimizing the positions of movable antennas (MAs) in wireless communication systems using Differential Evolution with One-in-One Representation (DEO). In traditional methods, such as Particle Swarm Optimization (PSO), antenna positions are represented collectively, leading to high computational costs and inefficient handling of constraints. The described techniques address these challenges by representing each antenna's position as an individual in an evolutionary process, which significantly reduces the dimensionality and computational complexity.

Moreover, the described techniques may incorporate an adaptive penalty mechanism in the fitness function, imposing penalties proportional to the severity of constraint violations. Such mechanisms may enhance convergence rates and ensures better satisfaction of constraints compared to traditional uniform penalty methods. The combination of the one-in-one representation and the adaptive penalty mechanism enables efficient optimization of antenna positions, making real-time adjustments feasible even in large-scale antenna systems.

The disclosed techniques may operate by updating individual antenna positions through mutation, crossover, and selection operations tailored to the one-in-one representation. Such techniques may be compatible with both continuous and discrete position optimization and may not require convexity in the objective function or constraints.

In a first aspect, a method includes determining first data corresponding to at least a subset of a plurality of antennas in a wireless communication system, wherein the first data includes separate position data corresponding to each of at least the subset of the plurality of antennas; determining, based on the first data, second data corresponding to target positions for at least the subset of the plurality of antennas, wherein the second data includes target positions for at least the subset of the plurality of antennas during an operational period of the wireless communication system, and wherein determining the second data includes applying an iterative evolutionary process to the first data to determine the target positions for at least the subset of the plurality of antennas; and adjusting the physical positions of at least the subset of the plurality of antennas based on the target positions for at least the subset of the plurality of antennas.

In a second aspect according to the first aspect, applying the iterative evolutionary process includes representing each of the separate position data corresponding to each of at least the subset of the plurality of antennas as an individual within the iterative evolutionary process.

In a third aspect according to the second aspect, the iterative evolutionary process includes a differential evolution process.

In a fourth aspect according to any one of the second through third aspects, the differential evolution process includes independently evolving each individual through mutation operations, crossover operations, selection operations, or a combination thereof.

In a fifth aspect according to the fourth aspect, the mutation operations include, for each antenna, generating modified position data by combining position data of randomly selected individuals.

In a sixth aspect according to any of the fourth and fifth aspects, the crossover operations include, for each antenna, recombining the modified position data with the corresponding current position data to produce trial position data.

In a seventh aspect according to any of the fourth through sixth aspects, the selection operations include selecting, for each antenna, between the trial position data and the current position data based on a first measure.

In an eighth aspect according to the seventh aspect, the first measure includes determining a second measure based on the severity of constraint violations.

In a ninth aspect according to the eighth aspect, the constraints include at least one of minimum inter-antenna spacing requirements to avoid coupling effects; boundary conditions confining antenna movement within a designated spatial region; or a combination thereof.

In a tenth aspect according to the ninth aspect, determining the second measure includes determining a measure of constraint violation by calculating a difference between actual antenna positions and positions satisfying the constraints; determining the second measure based on the degree of constraint violation; and further includes determining the first measure based on the second measure.

In an eleventh aspect according to the tenth aspect, the second measure increases proportionally with the extent to which the constraints are violated.

In a twelfth aspect according to any of the first through eleventh aspect, determining the second data includes applying the iterative evolutionary process to enhance a communication performance metric of the wireless communication system.

In a thirteenth aspect according to any of the first through twelfth aspect, the plurality of antennas are movable antennas configured to adjust positions within a predefined movable region during operation of the wireless communication system.

In a fourteenth aspect according to the thirteenth aspect, adjusting the physical positions includes moving each antenna within the predefined movable region to the corresponding target position specified in the second data.

In a fifteenth aspect according to any of the first through fourteenth aspect, the iterative evolutionary process is performed in real-time during operation of the wireless communication system.

In a sixteenth aspect according to any of the first through fifteenth aspect, the iterative evolutionary process includes alternating between a collective representation and an individual representation of the position data to balance exploration and exploitation in determining the target positions.

In a seventeenth aspect according to the sixteenth aspect, the collective representation treats all position data collectively as a single individual within the iterative evolutionary process during exploration phases; the individual representation treats each of the separate position data as an individual within the iterative evolutionary process during exploitation phases; or a combination thereof.

In an eighteenth aspect, a system includes a processor and a memory storing instructions which, when executed by the processor, cause the processor to perform operations including determining first data corresponding to at least a subset of a plurality of antennas in a wireless communication system, wherein the first data includes separate position data corresponding to each of at least the subset of the plurality of antennas; determining, based on the first data, second data corresponding to target positions for at least the subset of the plurality of antennas, wherein the second data includes target positions for at least the subset of the plurality of antennas during an operational period of the wireless communication system, and wherein determining the second data includes applying an iterative evolutionary process to the first data to determine the target positions for at least the subset of the plurality of antennas; and adjusting the physical positions of at least the subset of the plurality of antennas based on the target positions for at least the subset of the plurality of antennas.

In a nineteenth aspect according to the eighteenth aspect, the iterative evolutionary process includes a differential evolution process.

In a twentieth aspect, a non-transitory, computer-readable medium stores instructions which, when executed by a processor, cause the processor to perform operations including determining first data corresponding to at least a subset of a plurality of antennas in a wireless communication system, wherein the first data includes separate position data corresponding to each of at least the subset of the plurality of antennas; determining, based on the first data, second data corresponding to target positions for at least the subset of the plurality of antennas, wherein the second data includes target positions for at least the subset of the plurality of antennas during an operational period of the wireless communication system, and wherein determining the second data includes applying an iterative evolutionary process to the first data to determine the target positions for at least the subset of the plurality of antennas; and adjusting the physical positions of at least the subset of the plurality of antennas based on the target positions for at least the subset of the plurality of antennas.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the disclosed subject matter.

### BRIEF DESCRIPTION OF THE FIGURES

FIG. 1 illustrates depicts scenarios that utilize movable antennas according to one or more aspects of the present disclosure.

FIG. 2 illustrates a system for communicating via a base station with MAs according to one aspect of the present disclosure.

FIG. 3 illustrates a system for wireless communication using movable antennas according to certain aspects of the present disclosure.

FIG. 4 illustrates a scenario with different position data representations according to one aspect of the present disclosure.

FIGS. 5A-5C illustrate plots demonstrating test results according to aspects of the present disclosure.

FIG. 6 illustrates a method for operating movable antennas according to one aspect of the present disclosure.

FIG. 7 illustrates an example computer system according to one aspect of the present disclosure.

### DETAILED DESCRIPTION OF EXAMPLE EMBODIMENTS

Wireless communication systems are continually evolving to meet the increasing demand for higher data rates and enhanced connectivity. Multiple-input multiple-output (MIMO) systems have been instrumental in improving spectral efficiency by exploiting spatial degrees of freedom. Traditional MIMO systems, however, employ fixed-position antennas (FPAs), which limit their adaptability to dynamic channel variations. The inability of FPAs to adjust to changing environments can result in suboptimal communication performance, particularly in scenarios with significant channel fluctuations.

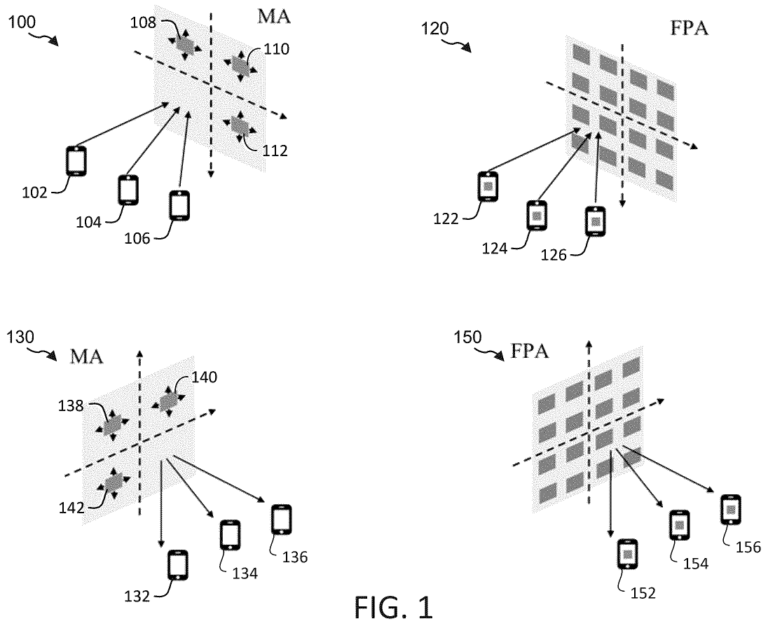

Movable Antennas (MAs) have emerged as a promising solution to address the limitations of FPAs. MAs introduce flexibility by allowing antennas to move within a designated spatial region. This mobility enables the wireless communication system to dynamically adjust antenna positions, improving communication performance in response to real-time conditions. For example, FIG. 1 depicts scenarios that utilize MAs according to one or more aspects of the present disclosure. In the scenario 100, a base station with MAs 108, 110, 112 receives uplink transmission(s) from user equipment (UEs) 102, 104, 106 with fixed-position antennas. In the scenario 120, a base station with FPA 128 receives uplink transmission(s) from UEs 122, 124, 126 with MAs. In the scenario 130, a base station with MAs 138, 140, 142 transmits downlink transmission(s) to UEs 132, 134, 136 with FPAs. In the scenario 150, a base station with FPA 158 transmits downlink transmission(s) to UEs 152, 154, 156 with MAs.

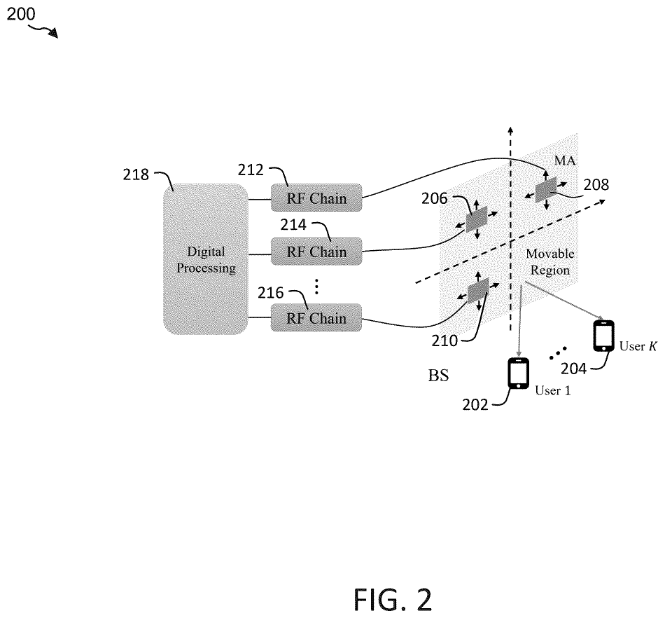

In greater detail, FIG. 2 shows a system 200 for communicating via a base station with MAs 206, 208, 210 according to one aspect of the present disclosure. In particular, the base station may be configured to perform digital processing 218 on signals that are transmitted or received. The system 200 then includes separate RF chains 212, 214, 216 corresponding to each of the MAs 206, 208, 210. The RF chains 212, 214, and 216 may include components such as digital-to-analog converters (DACs), analog-to-digital converters (ADCs), mixers, filters, amplifiers, and other necessary circuitry for signal modulation, demodulation, frequency conversion, and amplification. Each RF chain may process baseband signals from the digital processing unit 218, converting them into RF signals suitable for transmission via the corresponding movable antenna. Conversely, RF signals received by the MAs 206, 208, 210 may be converted back into baseband signals by the RF chains 212, 214, 216 for further digital processing.

The transmission may then be sent via the MAs 206, 208, 210 to multiple user equipment devices (UEs). The MAs 206, 208, 210 may transmit the processed RF signals into the wireless medium, establishing communication links with UEs located within the coverage area of the base station. This configuration may be used to simultaneously communicate with multiple UEs 220, 222, 224 by employing multi-user MIMO techniques. The base station may utilize spatial multiplexing, beamforming, or other advanced signal processing methods to manage concurrent transmissions to different UEs, optimizing the use of available spectral resources and enhancing overall network capacity.

Optimizing and/or updating MA positions is a complex task due to the intricate coupling between antenna positions and channel responses. The positions of the antennas directly affect the channel characteristics, creating a highly non-linear and non-convex optimization problem. Existing techniques may rely on Particle Swarm Optimization (PSO) for antenna position optimization in MA-enabled systems. PSO is a population-based heuristic optimization method inspired by the social behavior of birds flocking or fish schooling. In traditional PSO approaches applied to MA position optimization, an “all-in-one” representation is used, where each particle in the swarm represents the entire layout of all antenna positions. While PSO can effectively search the solution space, such approaches may lead to several issues.

First, the computational complexity of PSO grows proportionally with the number of iterations and the number of particles in the swarm. In the “all-in-one” representation, each particle has a high dimensionality, specifically 2N for two-dimensional movable regions, where N is the number of MAs. As the number of antennas increases, the dimensionality of the problem becomes large, resulting in prohibitively high computational costs. This makes real-time optimization impractical, especially for large-scale antenna arrays or when antennas have a considerable range of movement within the movable region.

Second, traditional fitness functions in PSO may impose uniform penalties on constraint violations, treating all violations equally regardless of their severity. Constraints may include factors such as minimum inter-antenna spacing to avoid coupling effects or boundary limitations of the movable region. Uniform penalty methods thus do not differentiate between minor and major violations, which can slow down the convergence of the algorithm and lead to suboptimal solutions. Minor violations are penalized to the same extent as significant ones, which does not effectively guide the optimization process toward feasible and optimal regions of the solution space.

These issues hinder the scalability and effectiveness of PSO-based methods in MA-enabled systems. When dealing with a large number of MAs or complex constraint conditions, the traditional PSO approach becomes computationally intensive and less efficient. The high computational cost makes PSO techniques unsuitable for real-time applications where rapid adjustments to antenna positions are required. Additionally, the inefficient handling of constraints may result in solutions that do not satisfy critical operational requirements, affecting the overall performance of the wireless communication system.

The present disclosure introduces new and efficient antenna position optimization techniques, which may be referred to as Differential Evolution with One-in-One Representation (DEO) for MA-enabled wireless communication systems. The DEO techniques address the key issues of high computational cost and inefficient fitness functions found in existing PSO-based methods by leveraging a novel representation and adaptive mechanisms.

In the proposed techniques, each antenna's position may be treated as an individual in the population of the evolutionary process. This approach may be referred to as the one-in-one representation. By representing each antenna's position separately, the dimensionality of each individual in the population is significantly reduced from 2N to 2 for two-dimensional movable regions (where N is the number of MAs). Consequently, the total number of individuals in the population is reduced to N, compared to the larger population sizes typically required in PSO with “all-in-one” representation. This reduction in dimensionality and population size greatly decreases the computational complexity of the optimization process. The DEO framework operates by updating the population of individual antenna positions using mutation, crossover, and selection operations that are adjusted to accommodate the one-in-one representation.

Additionally, the proposed techniques support an adaptive penalty mechanism, which may impose penalties proportional to the severity of constraint violations. Such implementations of the penalty may improve the convergence rate of the algorithm and leads to better satisfaction of constraints by actively discouraging solutions with significant violations while allowing minor violations to be corrected in subsequent iterations.

The proposed techniques may be compatible with both continuous and discrete position optimizations. In scenarios where antennas can occupy any position within the movable region, the proposed techniques operate in a continuous space. When antennas are limited to discrete positions due to mechanical constraints or design considerations, the techniques can be adapted by rounding continuous position data to the nearest allowable discrete values. Additionally, the proposed techniques may not impose specific requirements on the convexity of the objective function or constraints, making it suitable for complex optimization problems inherent in MA-enabled wireless communication systems.

Extensive numerical results demonstrate that the DEO framework achieves over 95% reduction in computational cost compared to PSO-based methods while attaining superior performance in optimizing antenna positions. The reduced computational complexity is attributed to the decreased dimensionality of the problem and the smaller population size required in the DEO framework. Additionally, the adaptive penalty mechanism enhances the efficiency of the optimization by effectively handling constraints.

In some aspects, the present disclosure provides techniques for optimizing antenna positions using differential evolution with a one-in-one representation that may be particularly beneficial in improving computational efficiency and constraint handling in wireless communication systems. For example, by reducing the dimensionality of the optimization problem, the DEO framework significantly decreases computational costs, which may achieve over 95% reduction compared to traditional PSO methods. This makes real-time optimization of antenna positions feasible even in large-scale systems with numerous antennas.

The adaptive penalty mechanism enhances the convergence rate and ensures better satisfaction of constraints by penalizing constraint violations proportionally to their severity. This leads to more reliable and optimal solutions, improving overall communication performance. The disclosed techniques may accordingly improve the experience for end users by enabling more stable and higher-quality wireless connections, as the optimized antenna positions can adapt to changing environmental conditions and user demands more effectively.

Additionally, the disclosed techniques can improve the functioning of computing devices within the wireless communication system by reducing the computational load required for antenna position optimization. The lower computational complexity allows for the use of less powerful processors or frees up resources for other critical tasks within the system. Furthermore, the flexibility of the DEO framework to handle both continuous and discrete position optimization without requiring convexity in the objective function or constraints makes it adaptable to various implementation scenarios and practical system constraints.

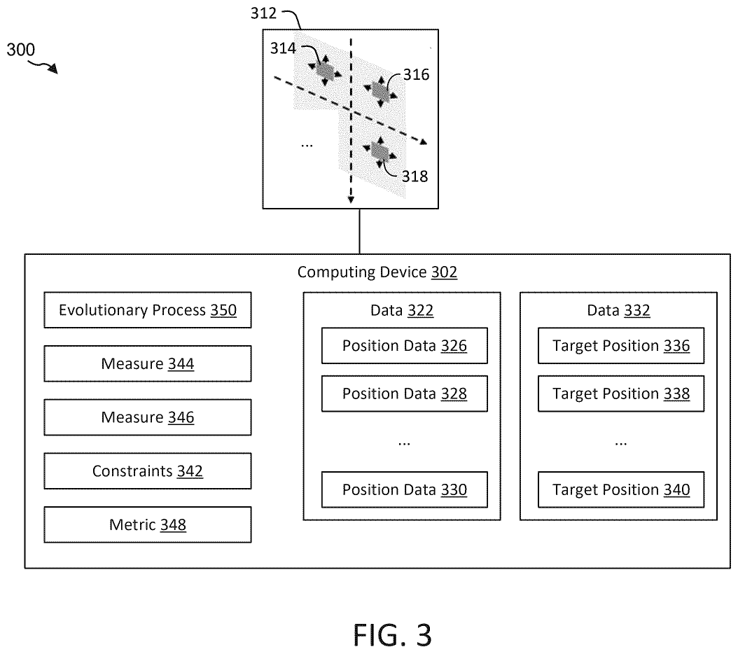

FIG. 3 depicts a system 300 for wireless communication according to certain aspects of the present disclosure. The system 300 may include a plurality of antennas 314, 316, and 318, which may be utilized to transmit and/or receive data within a wireless communication network. The system 300 may be configured to facilitate communication between multiple users and network nodes, supporting various wireless communication protocols and standards. The antennas 314, 316, and 318 may operate collaboratively to enable efficient data transmission and reception under different operational environments.

In certain implementations, the wireless communication system 300 may be a multi-user multiple-input multiple-output (MIMO) system. The overall architecture of such a system may include multiple users communicating simultaneously with the base station equipped with the plurality of antennas 312. The system may support various protocols or standards, such as Long-Term Evolution (LTE), 5G New Radio (5G NR), or Wi-Fi standards like IEEE 802.11ax.

At least a subset of the antennas may be configured to support physical movement. For example, the antennas 314, 316, and 318 may have physical characteristics that enable movement, such as being mounted on mechanical actuators. The mechanical actuators may include devices such as motors, rails, or robotic arms that allow for precise control of the antennas' positions. The movement capabilities of the antennas 312 may enable dynamic adjustment of antenna positions to optimize communication performance during operation.

The antennas 312 may be configured to support changes in physical positions within a predefined movable region during operation of the wireless communication system 300. The predefined movable region may be a two-dimensional area or a three-dimensional space, depending on system design requirements. For example, in certain implementations, the movable region may be a two-dimensional plane defined by X and Y coordinates, allowing antennas to move horizontally and vertically within that plane. In other implementations, the movable region may be a three-dimensional space, providing movement along X, Y, and Z axes, which may offer greater flexibility in antenna positioning.

The antennas 312 may be constrained within this predefined movable region by mechanical limits of the actuators or by system-defined boundaries to ensure proper operation and to prevent physical interference with other components. The constraints may also include considerations for safety, structural integrity, and compliance with regulatory standards.

In certain implementations, the system 300 may be configured to determine first data 322 corresponding to at least a subset of a plurality of antennas 312 in a wireless communication system 300. The first data 322 may include separate position data corresponding to each of at least the subset of the plurality of antennas 312. In certain implementations, the first data 322 may include current physical positions of at least the subset of the plurality of antennas 312. The system 300 may be configured to determine the first data 322 using methods, sensors, or devices that provide positional information. For example, each antenna 314, 316, and 318 may be equipped with one or more position sensors such as encoders, potentiometers, accelerometers, or a combination thereof that provide real-time position data to the computing device 302.

For instance, the position data may include separate position data 326 for antenna 314, position data 328 for antenna 316, and position data 330 for antenna 318. As an example, the system 300 may initialize with the antennas 312 in default positions within the movable region. During operation, changing environmental conditions, user mobility, or network demands may require adjustments to antenna positions. The computing device 302 may periodically or continuously gather the first data 322 to monitor the antennas' positions and determine if adjustments are necessary to maintain or enhance communication performance.

The hardware configurations that enable the antennas 312 to be movable may include the mechanical actuators connected to each antenna 314, 316, and 318. The mechanical actuators may be controlled by the computing device 302, which may send control signals to adjust the positions of the antennas based on calculated requirements. The actuators may provide movements in one or more axes, depending on the design. For example, linear actuators may move antennas along a straight line, while rotary actuators may adjust angles or orientations.

The ability of the antennas 312 to adjust positions within the predefined movable region may enable the system 300 to adapt to changing communication needs. By determining the first data 322 and understanding the current configuration of the antenna array, the system 300 may make informed decisions on how to reposition antennas to optimize network performance.

As another example, during peak network usage times, the computing device 302 may analyze the first data 322 to identify areas with high user density. The antennas 312 may then be repositioned within the movable region to improve coverage and signal quality in those areas. The mechanical actuators controlled by the computing device 302 may execute these adjustments smoothly and efficiently.

In certain implementations, the predefined movable region may have specific constraints to ensure proper functioning of the system 300. For instance, physical boundaries may prevent antennas 312 from moving beyond certain limits, and software-defined zones may restrict movement to comply with interference regulations or to avoid obstacles. The computing device 302 may account for these constraints when determining permissible positions within the first data 322.

Overall, the system 300 may be configured to determine first data 322 that includes separate position data for each antenna 314, 316, and 318. By leveraging the capabilities of the movable antennas 312 and associated hardware like mechanical actuators and sensors, the system 300 may effectively monitor and adjust antenna positions to enhance communication performance within the wireless communication system 300.

In certain implementations, the system 300 may be configured to determine, based on the first data 322, second data 332 corresponding to target positions for at least a subset of the plurality of antennas 312. The second data 332 may include target positions for at least the subset of the plurality of antennas 312 during an operational period of the wireless communication system 300. Determining the second data 332 may include applying an iterative evolutionary process 350 to the first data 322 to determine the target positions for at least the subset of the plurality of antennas 312.

In certain implementations, the system 300 may utilize a one-in-one representation within the iterative evolutionary process 350 when determining the target positions. The one-in-one representation may involve treating each antenna's position data 326, 328, and 330 as an individual within the evolutionary process, rather than aggregating all antennas' positions into a single individual. For example, each antenna's position, such as antenna n, may be represented as a vector tₙ=[xₙ,yₙ] in a two-dimensional movable region or tₙ=[xₙ,yₙ,zₙ] in a three-dimensional movable region. The iterative evolutionary process 350 may independently evolve each antenna's position by applying mutation, crossover, and selection operations directly to these individual vectors.

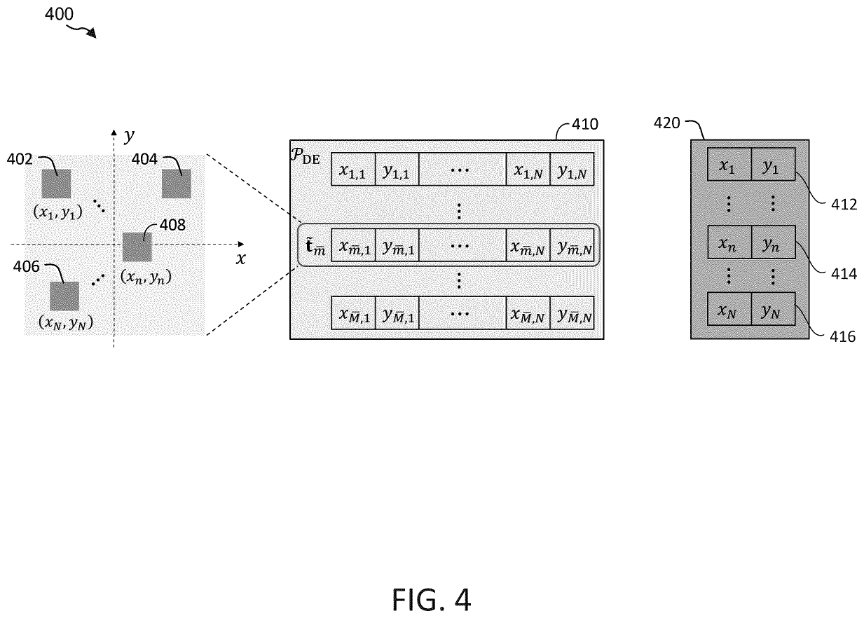

As another example, FIG. 4 shows a scenario 400 with different position data representations according to one aspect of the present disclosure. In particular, the scenario 400 includes multiple MAs 402, 404, 406, 408, each with corresponding position data. In a first representation 410, each iteration has a single vector that includes the position information for all of the antennas 402, 404, 406, 408. In the second representation 420, which may be an exemplary implementation of a one-in-one representation, each iteration has separate vectors 412, 414, 416 containing position information for corresponding antennas 402, 404, 406, 408.

As explained further herein, by utilizing the one-in-one representation, the computing device 302 may focus on optimizing each antenna's position separately. This individual treatment allows for more granular control over the antenna positions and may lead to faster convergence in the optimization process. The one-in-one representation may be particularly advantageous in systems with a large number of antennas 312, where a collective representation may become computationally intensive.

In certain implementations, applying the iterative evolutionary process 350 may include representing each of the separate position data corresponding to each of at least the subset of the plurality of antennas 312 as an individual within the iterative evolutionary process 350. In certain implementations, the iterative evolutionary process 350 may initialize by randomly sampling position data within the predefined movable region. This may involve generating initial position data for each antenna 312 by selecting random positions within the allowed movement boundaries. The random sampling method may ensure a diverse initial population, which may improve the ability of the process to explore the solution space effectively. For example, the computing device 302 may generate random coordinates for each antenna 314, 316, and 318 within the movable region defined by the system constraints. This diverse initial population may help prevent premature convergence and improve the chances of finding a global optimum.

In certain implementations, the iterative evolutionary process 350 may be a differential evolution process. The differential evolution process may include independently evolving each individual through mutation operations, crossover operations, selection operations, or a combination thereof. For example, the mutation operations may, for each antenna, generate modified position data by combining position data of randomly selected individuals. Specifically, the computing device 302 may select three distinct individuals from the population—position data 326, 328, and 330 corresponding to different antennas—and may generate modified position data by adding the weighted difference between two of the selected position data to the third. This may be expressed mathematically as: vₙ=tᵣ₁+F×(tᵣ₂−tᵣ₃), where vₙ is the modified position data for antenna n, tᵣ₁, tᵣ₂, and tᵣ₃ are position data of randomly selected antennas, and F is a scaling factor.

The crossover operations may, for each antenna, recombine the modified position data with the corresponding current position data to produce trial position data. This may involve, for each component of the position data (e.g., X, Y, Z coordinates), deciding whether to use the value from the modified position data or the current position data based on a crossover probability C_{R}. For example, the trial position data uₙ for antenna n may be determined as:

$${[ {u}_{n} ]}_{j} = \{ \begin{matrix}{[ {v}_{n} ]}_{j} , & if {r}_{j} \leq {C}_{R} or j = {j}_{\text{?}} \\ {[ {t}_{n} ]}_{j} , & otherwise\end{matrix}$$

$$\text{?} \text{indicates text missing or illegible when filed}$$

where [uₙ]ⱼ is the j-th component of the trial position data, [vₙ]ⱼ is the j-th component of the modified position data, [tₙ]ⱼ is the j-th component of the current position data, rⱼ is a random number between 0 and 1, and j_{rand} is a randomly selected index ensuring at least one component is taken from the modified position data. This operation may help introduce new variations while retaining useful characteristics from the current positions.

The selection operations may involve selecting, for each antenna, between the trial position data and the current position data based on a first measure 344. The first measure 344 may include determining a second measure 346, which may be referred to as an adaptive penalty, based on the severity of constraint violations. The adaptive penalty may be determined to quantify the extent to which the trial position data violates predefined constraints 342. The computing device 302 may calculate a performance metric 348 for both the trial position data and the current position data, and then adjust these metrics by adding an adaptive penalty if any constraints 342 are violated.

In certain implementations, the constraints 342 may include minimum inter-antenna spacing requirements to avoid coupling effects, boundary conditions confining antenna movement within the designated movable region, or a combination thereof. The adaptive penalty may be proportional to the extent of the constraint violations. For instance, if the minimum spacing requirement is violated by a certain distance, the penalty may increase correspondingly. In certain implementations, the first measure 344 may be determined as First Measure=Performance Metric+Second Measure. The second measure 346 may improve convergence rates and constraint satisfaction compared to uniform penalty methods by penalizing solutions that violate constraints more severely, guiding the iterative evolutionary process 350 towards feasible and optimal solutions.

In certain implementations, the computing device 302 may apply the iterative evolutionary process 350 to enhance a communication performance metric 348 of the wireless communication system 300. The communication performance metric 348 may include at least one of weighted sum-rate, signal-to-interference-plus-noise ratio (SINR), spectral efficiency, channel capacity, or a combination thereof.

For example, the weighted sum-rate R may be determined as

$$R = {\sum }_{k = 1}^{K} {ω}_{k} {log}_{2} ( 1 + {SINR}_{k} ) ,$$

wherein ωₖ is the weight factor for user k, and SINRₖ is the signal-to-interference-plus-noise ratio for user k. The computing device 302 may estimate SINRₖ based on the trial position data and the current network conditions.

Enhancing the communication performance metric may be performed without requiring convexity of the objective function or constraints. The iterative evolutionary process 350 may operate on non-convex objective functions and handle non-convex constraints effectively. This may be particularly useful in wireless communication systems where the relationship between antenna positions and performance metrics is complex and non-linear.

In certain implementations, the computing device 302 may employ global optimization techniques and heuristic search methods inherent in the differential evolution process to navigate the non-convex solution space efficiently. Specifically, the differential evolution algorithm may utilize population-based search strategies, employing mutation and crossover operations to explore multiple regions of the solution space simultaneously. By maintaining a diverse population of candidate solutions and applying stochastic perturbations, the iterative evolutionary process 350 may reduce the likelihood of converging to local optima. This approach enables the computing device 302 to explore a wide range of potential solutions and to identify optimal or near-optimal antenna positions even in complex, non-linear environments.

In certain implementations, the computing device 302 may manage the iterative evolutionary process 350 in real-time during operation of the wireless communication system 300. This may involve continuously updating the first data 322, recalculating the second data 332, and adjusting the antenna positions as network conditions change.

As an example, if the system 300 detects a drop in network performance due to increased interference or congestion, the computing device 302 may initiate the iterative evolutionary process 350 to find new target positions for the antennas 312. By adapting the antenna positions in response to real-time data, the system 300 may maintain optimal communication performance.

Overall, the system 300 may be configured to determine second data 332 corresponding to target positions for the antennas 312 by applying an iterative evolutionary process 350 to the first data 322. By leveraging techniques such as differential evolution, adaptive penalty mechanisms, and real-time processing, the system 300 may effectively optimize antenna positions to enhance communication performance metrics within the wireless communication system 300.

In certain implementations, the system 300 may be configured to perform the iterative evolutionary process 350 in real-time during operation of the wireless communication system 300. Performing the process in real-time may involve continuously or periodically updating the target positions based on the latest first data 322 and current network conditions. Real-time operation may be enabled by computational optimizations and hardware considerations that allow for rapid processing and decision-making.

For example, the computing device 302 may utilize parallel processing techniques, such as multi-threading or leveraging multi-core processors, to accelerate computations involved in the iterative evolutionary process 350. Additionally, specialized hardware components like Graphics Processing Units (GPUs) or Field-Programmable Gate Arrays (FPGAs) may be employed to perform intensive mathematical calculations more efficiently. Memory optimizations, such as using high-speed cache or reducing data copying, may further enhance performance to meet real-time requirements.

In certain implementations, the iterative evolutionary process 350 may be configured to alternate between utilizing a collective representation and an individual representation of the position data to balance exploration and exploitation in determining the target positions. During exploration phases, the computing device 302 may employ a collective representation wherein the position data of all antennas 312 are aggregated into a single individual within the evolutionary process. This collective approach allows the computing device 302 to consider the antenna array as a whole, facilitating the exploration of the broader search space and capturing the collective interactions among antennas.

During exploitation phases, the computing device 302 may utilize the individual representation, as previously described, where each antenna's position data 326, 328, and 330 is treated as an individual within the iterative evolutionary process 350. This individual representation focuses on fine-tuning the positions of individual antennas 312, optimizing local performance metrics, and refining solutions identified during the exploration phase. By alternating between these two representations, the computing device 302 may effectively balance global search capabilities with local optimization.

For example, the computing device 302 may initiate the iterative evolutionary process 350 using the collective representation to broadly explore potential configurations of the antenna array. The computing device 302 may be configured to monitor the performance metric 348 during this phase. If the computing device 302 determines that the rate of improvement in the performance metric 348 falls below a predefined threshold or after a predetermined number of iterations, the computing device 302 may switch to the individual representation. In response to this determination, the computing device 302 may reconfigure the evolutionary process to treat each antenna's position data 326, 328, and 330 as separate individuals. The computing device 302 may then focus on refining the positions of individual antennas 312 to further enhance local performance metrics. This alternation between collective and individual representations may continue as needed, with the computing device 302 dynamically adjusting the optimization strategy based on convergence rates, performance improvements, or other predefined criteria. By implementing this adaptive approach, the system 300 may effectively balance global exploration with local exploitation in the optimization process.

In certain implementations, the iterative evolutionary process 350 may include applying a genetic algorithm instead of a differential evolution process. A genetic algorithm may involve operations such as selection, crossover, and mutation, inspired by the process of natural selection. The computing device 302 may represent possible antenna positions as chromosomes and apply genetic operators to evolve the population over successive generations.

For instance, the genetic algorithm may select parent solutions based on their fitness, perform crossover to produce offspring by combining parts of parent chromosomes, and apply mutations to introduce randomness. The use of a genetic algorithm may offer advantages in handling complex, multimodal optimization problems and may provide alternative pathways to finding optimal antenna positions. The choice between a genetic algorithm and a differential evolution process may depend on factors such as problem characteristics, computational resources, and optimization goals.

In determining the second data 332, the computing device 302 may consider continuous position data, discrete position data, or a combination thereof for the antennas 312. Continuous position optimization involves finding target positions within a continuous range of values in the movable region, allowing for precise adjustments. Discrete position optimization may involve selecting positions from a set of predefined discrete values, which may simplify the implementation or comply with hardware constraints.

For example, the antennas 312 may only be able to occupy certain fixed positions due to mechanical limitations. In such cases, the computing device 302 may handle discrete positions by rounding continuous position data to the nearest discrete values within the movable region. This method of determining discrete positions by rounding may involve adjusting the calculated target positions to align with available positions.

While this approach may slightly reduce the precision of the optimization, it may be necessary to accommodate physical constraints. The trade-off may involve balancing the optimality of antenna positions against practical implementation considerations. The computing device 302 may account for these trade-offs when performing the iterative evolutionary process 350.

In certain implementations, the iterative evolutionary process 350 may incorporate additional techniques to enhance optimization. For example, the computing device 302 may utilize reinforcement learning methods to adjust algorithm parameters dynamically based on observed performance. The computing device 302 may monitor key indicators such as convergence speed or solution diversity and modify parameters like the scaling factor F or crossover probability C_{R} accordingly. By employing adaptive parameter control, the computing device 302 may improve the efficiency and effectiveness of the optimization process, allowing it to respond to changing network conditions and optimization landscapes.

In certain implementations, the system 300 may be configured to adjust the physical positions of at least a subset of the plurality of antennas 312 based on the target positions for at least the subset of the plurality of antennas 312. Adjusting the physical positions may involve moving each antenna within the predefined movable region to the corresponding target position specified in the second data 332. For example, each of the antennas 314, 316, 318 to their respective target positions 336, 338, and 340 by controlling the operation of the mechanical actuators.

The computing device 302 may control these mechanical actuators using appropriate communication protocols, control processes, and feedback systems. Communication between the computing device 302 and the mechanical actuators may occur over wired or wireless interfaces, utilizing protocols such as Ethernet, CAN bus, Modbus, or proprietary protocols designed for real-time control. The control processes implemented by the computing device 302 may include motion planning, trajectory generation, and servo control to ensure smooth and accurate movements.

In certain implementations, one or more feedback systems may be employed to monitor the positions of the antennas 312 during movement. Position sensors, such as encoders, potentiometers, or laser position sensors, may provide real-time data to the computing device 302, allowing it to adjust control signals and correct any deviations from the intended path. This closed-loop control may enhance the precision and reliability of the antenna adjustments.

Prior to adjusting the physical positions, the system 300 may be configured to verify that the target positions satisfy predefined operational constraints 342 of the wireless communication system 300. These constraints may include maintaining minimum distances between antennas to prevent electromagnetic interference or coupling effects, adhering to mechanical limits, and complying with regulatory or safety requirements.

For example, the computing device 302 may evaluate the target positions against the constraints 342 by calculating the distances between each pair of antennas 312. If any pair of antennas is found to be closer than the minimum allowed distance, the computing device 302 may adjust the target positions or rerun the iterative evolutionary process 350 to find alternative solutions that meet the constraints.

The predefined operational constraints 342 may be configured and/or specified in the system's configuration. Constraints to maintain minimum inter-antenna spacing may prevent signal interference or unwanted coupling between antennas. Additional or alternative constraints may include maximum or minimum elevation angles, limits on mechanical travel, or areas designated as restricted zones due to physical obstructions or regulatory compliance.

In certain implementations, the computing device 302 may further determine beamforming parameters for at least the subset of the plurality of antennas 312 based on the target positions. Determining the beamforming parameters may involve applying a weighted minimum mean square error (WMMSE) algorithm. The WMMSE algorithm may optimize the beamforming weights to enhance signal quality and reduce interference among users in the wireless communication system 300. For example, the computing device 302 may utilize the target positions to calculate channel state information (CSI) for each antenna 314, 316, and 318. Using the CSI, the WMMSE algorithm may solve an optimization problem to find beamforming weights that minimize the mean square error between the transmitted and received signals, subject to power constraints and quality of service requirements.

The mathematical formulation of the WMMSE algorithm may involve setting up an objective function to minimize

$$Objective Function = {\sum }_{k = 1}^{K} {ω}_{k} E [ {\vert {s}_{k} - \text{?} \vert}^{2} ] ,$$

where ωₖ is the weight for user k, sₖ is the transmitted signal, and [symbol] is the received signal estimate. The computing device 302 may iteratively adjust the beamforming weights until convergence is achieved.

In the outer layer, the computing device 302 may adjust the antenna positions using the iterative evolutionary process 350 to optimize the communication performance metric 348, such as the weighted sum-rate, based on the optimized beamforming vectors from the inner layer. This two-layer approach allows the computing device 302 to jointly optimize the beamforming and antenna positions iteratively until convergence is achieved.

The system 300 may handle multiple users by employing spatial multiplexing, beamforming, and advanced signal processing techniques. The computing device 302 may manage user scheduling, resource allocation, and signal processing to ensure efficient utilization of system resources.

If the antennas 312 are part of a base station in the wireless communication system 300, they may serve as the primary transmit and receive elements facilitating communication with user equipment (UE). In this role, the antennas 312 may be strategically positioned and adjusted to optimize coverage, capacity, and quality of service for connected devices.

Alternatively, if the antennas 312 are part of user equipment in the wireless communication system 300, they may enable the UE to adjust its antenna configuration to improve connectivity with the base station. This may be particularly useful in challenging environments where signal conditions vary, such as in mobile or dense urban scenarios.

The computing device 302 may be configured to terminate the process 350 upon determining that the process satisfies a convergence criterion or reaches a maximum number of iterations. In certain implementations, the convergence criteria may involve several conditions that the computing device 302 evaluates to determine whether to conclude the optimization process. As one example, the computing device 302 may define a target value for the performance metric 348, such as a specific weighted sum-rate R_{target}. If the computed performance metric 348 meets or exceeds R_{target}, the computing device 302 may terminate the iterative evolutionary process 350, recognizing that the desired performance level has been achieved.

As another example, the computing device 302 may monitor the relative improvement ΔR in the performance metric 348 between successive iterations. The relative improvement ΔR may be calculated as ΔR=(R_{current}−Rₚᵣₑᵥᵢₒᵤₛ)/Rₚᵣₑᵥᵢₒᵤₛ, where R_{current} IS a performance metric at a current iteration, and Rₚᵣₑᵥᵢₒᵤₛ is a performance metric from a previous iteration. In certain implementations, if ΔR falls below a predefined value, indicating marginal gains, the computing device 302 may be configured to consider the process to have converged and may terminate the iterative evolutionary process 350.

As a further example, the computing device 302 may observe the stability of antenna positions or performance metrics over a set number of iterations Nₛ. If the variations in these parameters remain within acceptable bounds during Nₛ consecutive iterations, it may indicate convergence. In such cases, the computing device 302 may decide that continuing the process is unlikely to yield significant improvements and may terminate the optimization.

In additional or alternative implementations, the computing device 302 may ensure that all constraints 342 are satisfied. If no constraint violations occur over a specified number of iterations, the computing device 302 may determine that the solution is feasible and may conclude the iterative evolutionary process 350 accordingly.

In certain implementations, regardless of other criteria, the computing device 302 may be configured to terminate the process after reaching a maximum number of iterations Nₘₐₓ to prevent excessive computational load. By implementing these convergence criteria, the computing device 302 may efficiently determine when to conclude the iterative evolutionary process 350, balancing optimization goals with computational resources.

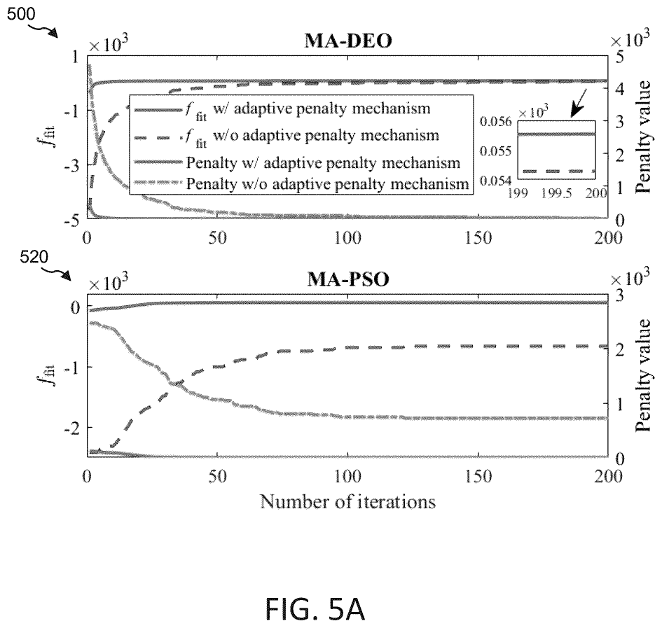

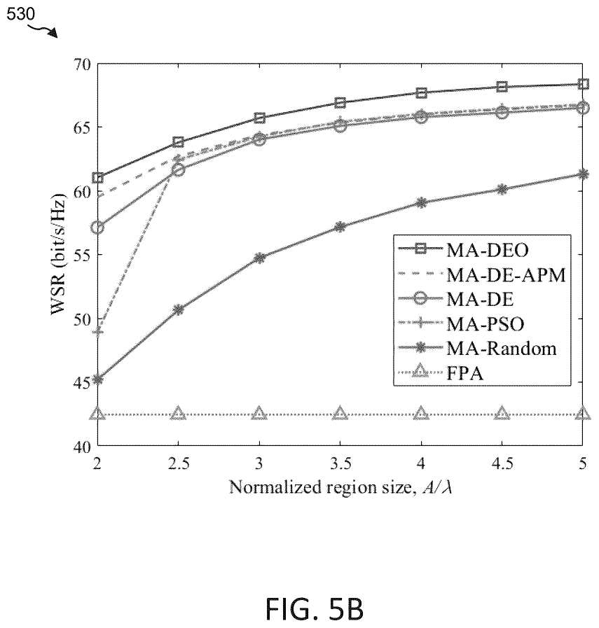

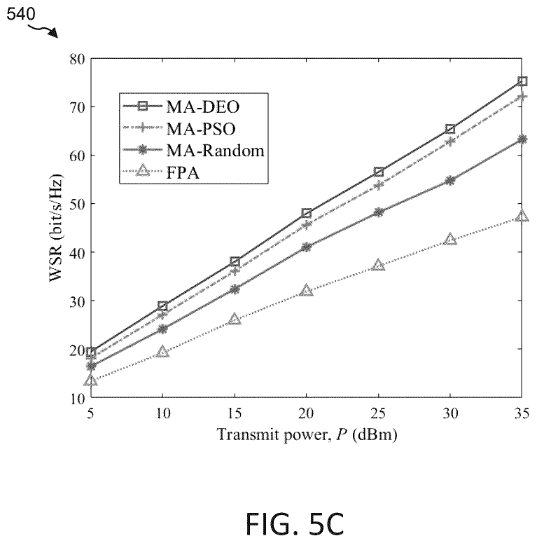

The techniques described herein may be implemented to realize various benefits. For example, the disclosed techniques may enable more rapid convergence to high-quality solutions when optimizing antenna positions in movable-antenna (MA) systems. In particular, FIG. 5A depicts plots 500, 520 demonstrating test results according to one aspect of the present disclosure. The top plot 500 illustrates the performance of an MA differential evolution process (MA-DEO) with and without an adaptive penalty mechanism, while the bottom plot 520 illustrates the performance of an MA particle swarm optimization process (MA-PSO) under similar conditions. In each plot 500, 520, the horizontal axis corresponds to the number of iterations, the left vertical axis indicates a fitness function value (frit) in the order of 10³, and the right vertical axis indicates a penalty value in the order of 10³. As can be observed from the plot 500, employing the disclosed techniques (i.e., using an adaptive penalty mechanism) within MA-DEO substantially speeds up convergence and reduces the penalty incurred by constraint violations. By contrast, the bottom plot 520 shows that the MA-PSO approach requires more iterations to converge, and even then, converges to a lower ultimate fitness value.

As another example, the disclosed techniques may facilitate position optimization within a normalized region of a given size, where “normalized region size” is represented as A/λ to indicate the ratio of the movable region's length A to the carrier wavelength λ. In particular, FIG. 5B depicts plot 530, which compares the weighted sum-rate (WSR, in bits/s/Hz) achieved by several approaches—namely, Movable-Antenna Differential Evolution with One-in-One Representation (MA-DEO), Movable-Antenna Differential Evolution with Adaptive Penalty Mechanism (MA-DE-APM), Movable-Antenna Differential Evolution (MA-DE), Movable-Antenna Particle Swarm Optimization (MA-PSO), Movable-Antenna Random Placement (MA-Random), and Fixed-Position Antenna (FPA)—across varying normalized region sizes between 2 and 5. In this plot, the horizontal axis represents the increasing normalized region size (A/λ), while the vertical axis indicates the WSR. Although FPA shows a nearly constant, lower WSR over the entire range, MA-Random, MA-PSO, and the differential-evolution-based methods (i.e., MA-DE, MA-DE-APM, and MA-DEO) exhibit higher WSRs that improve substantially with larger region sizes. Among these, MA-DEO consistently achieves the best or near-best performance, demonstrating that the disclosed techniques and an expanded movable region can significantly enhance communication performance.

As a further example, the disclosed techniques may reduce the transmit power required within wireless communication systems. In particular, FIG. 5C illustrates plot 540, which compares several approaches—namely MA-DEO, MA-PSO, MA-Random, and FPA—across a range of transmit power values P (from approximately 5 dBm to 35 dBm). The horizontal axis corresponds to the increasing transmit power, while the vertical axis indicates the resulting weighted sum-rate (WSR) in bits/s/Hz for each approach. In general, higher transmit powers lead to improved WSR for all methods. However, FPA consistently yields lower WSR values over the entire power range. MA-Random achieves moderate improvements beyond FPA, while MA-PSO attains a further increase in WSR. Among the methods shown, MA-DEO obtains the highest WSR across the examined power levels, demonstrating that the disclosed techniques are particularly effective in leveraging increased transmit power to enhance overall system performance.

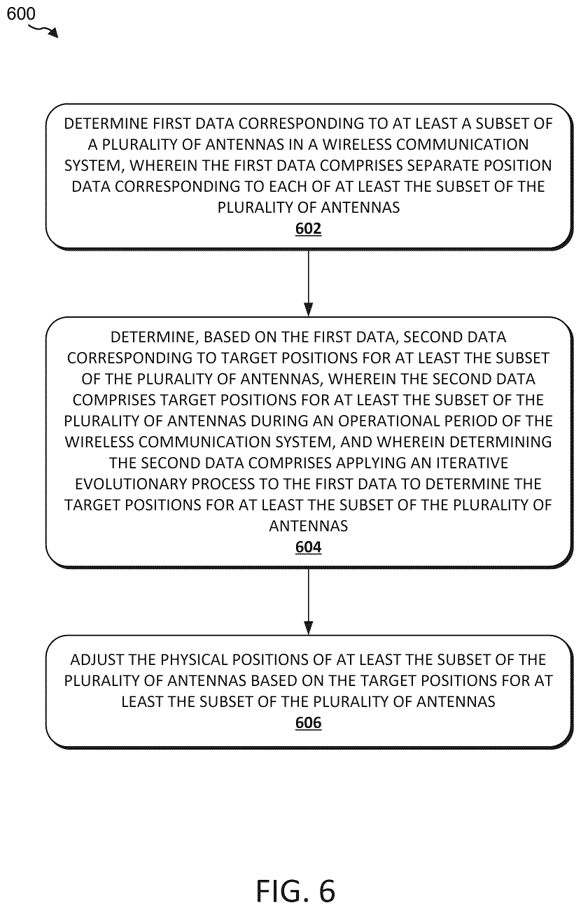

FIG. 6 depicts a method 600 for operating movable antennas according to one aspect of the present disclosure. The method 600 may be implemented on a computer system, such as the system 300. For example, the method 600 may be implemented by the computing device 302. The method 600 may also be implemented by a set of instructions stored on a computer-readable medium that, when executed by a processor, cause the computing device to perform the method 600. Although the examples below are described with reference to the flowchart illustrated in FIG. 6, many other methods of performing the acts associated with FIG. 6 may be used. For example, the order of some of the blocks may be changed, certain blocks may be combined with other blocks, one or more of the blocks may be repeated, and some of the blocks may be optional.

At block 602, the method 600 includes determining first data corresponding to at least a subset of a plurality of antennas in a wireless communication system, where the first data includes separate position data corresponding to each of at least the subset of the plurality of antennas. For example, the computing device 302 may determine first data 322 corresponding to at least a subset of the plurality of antennas 312 in the wireless communication system 300, where the first data 322 includes separate position data corresponding to each of at least the subset of the plurality of antennas 312. In certain implementations, the plurality of antennas 312 may be movable antennas configured to adjust positions within a predefined movable region during operation of the wireless communication system 300. In certain implementations, the predefined movable region may be a two-dimensional area or a three-dimensional space. In certain implementations, the first data 322 may include current physical positions of at least the subset of the plurality of antennas 312.

At block 604, the method 600 includes determining, based on the first data, second data corresponding to target positions for at least the subset of the plurality of antennas, where the second data includes target positions for at least the subset of the plurality of antennas during an operational period of the wireless communication system, and determining the second data includes applying an iterative evolutionary process to the first data to determine the target positions for at least the subset of the plurality of antennas. For example, the computing device 302 may determine, based on the first data 322, second data 332 corresponding to target positions for at least the subset of the plurality of antennas 312, where the second data 332 includes target positions for at least the subset of the plurality of antennas 312 during an operational period of the wireless communication system 300, and determining the second data 332 may include applying an iterative evolutionary process 350 to the first data 322 to determine the target positions for at least the subset of the plurality of antennas 312. In certain implementations, applying the iterative evolutionary process 350 includes representing each of the separate position data corresponding to each of at least the subset of the plurality of antennas 312 as an individual within the iterative evolutionary process 350. In certain implementations, the iterative evolutionary process 350 includes a differential evolution process. In certain implementations, the differential evolution process includes independently evolving each individual through mutation operations, crossover operations, selection operations, or a combination thereof. In certain implementations, the mutation operations include, for each antenna, generating modified position data by combining position data of randomly selected individuals. In certain implementations, the crossover operations include, for each antenna, recombining the modified position data with the corresponding current position data to produce trial position data. In certain implementations, the selection operations include selecting, for each antenna, between the trial position data and the current position data based on a first measure. In certain implementations, the first measure includes determining an adaptive penalty based on the severity of constraint violations. In certain implementations, the adaptive penalty improves convergence rate and constraint satisfaction compared to uniform penalty methods. In certain implementations, the constraints 342 include at least one of minimum inter-antenna spacing requirements to avoid coupling effects, boundary conditions confining antenna movement within a designated spatial region, or a combination thereof. In certain implementations, the adaptive penalty includes determining a measure of constraint violation by calculating a difference between actual antenna positions and positions satisfying the constraints; determining a penalty measure based on the degree of constraint violation; and determining the first measure based on the penalty measure. In certain implementations, the penalty measure increases proportionally with the extent to which the constraints are violated.

In certain implementations, determining the second data includes applying the iterative evolutionary process 350 to enhance a communication performance metric 348 of the wireless communication system 300. In certain implementations, the communication performance metric 348 includes at least one of weighted sum-rate, signal-to-interference-plus-noise ratio (SINR), spectral efficiency, channel capacity, or a combination thereof. In certain implementations, enhancing the communication performance metric 348 is performed without requiring convexity of the objective function or constraints. In certain implementations, the iterative evolutionary process 350 operates on non-convex objective functions and handles non-convex constraints effectively. In certain implementations, the iterative evolutionary process 350 initializes by randomly sampling position data within the predefined movable region. In certain implementations, the iterative evolutionary process 350 is performed in real-time during operation of the wireless communication system 300. In certain implementations, the iterative evolutionary process 350 includes alternating between a collective representation and an individual representation of the position data to balance exploration and exploitation in determining the target positions. In certain implementations, the collective representation treats all position data collectively as a single individual within the iterative evolutionary process 350 during exploration phases, and the individual representation treats each of the separate position data as an individual within the iterative evolutionary process 350 during exploitation phases. In certain implementations, the iterative evolutionary process 350 includes applying a genetic process. In certain implementations, determining the second data 332 considers both continuous and discrete position optimization for the antennas 312. In certain implementations, determining the second data 332 includes determining discrete positions for the target positions by rounding continuous position data to the nearest discrete values within the movable region.

In certain implementations, the method 600 further includes determining beamforming parameters for at least the subset of the plurality of antennas 312 based on the target positions. In certain implementations, determining the beamforming parameters includes applying a weighted minimum mean square error (WMMSE) algorithm.

At block 606, the method 600 includes adjusting the physical positions of at least the subset of the plurality of antennas based on the target positions for at least the subset of the plurality of antennas. For example, the computing device 302 may adjust the physical positions of at least the subset of the plurality of antennas 312 based on the target positions for at least the subset of the plurality of antennas 312. In certain implementations, adjusting the physical positions includes moving each antenna within the predefined movable region to the corresponding target position specified in the second data 332. In certain implementations, prior to adjusting the physical positions, the method 600 further includes verifying that the target positions satisfy predefined operational constraints 342 of the wireless communication system 300. In certain implementations, the predefined operational constraints 342 include maintaining minimum distances between antennas to prevent electromagnetic interference. In certain implementations, the antennas 312 are configured to move via mechanical actuators controlled by the computing device 302.

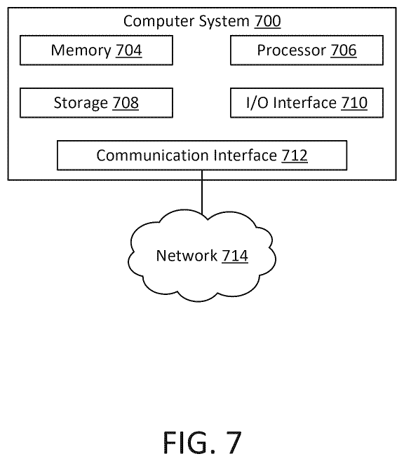

FIG. 7 illustrates an example computer system 700 that may be utilized to implement one or more of the devices and/or components discussed herein, such as the computing device 302. In particular embodiments, one or more computer systems 700 perform one or more steps of one or more methods described or illustrated herein, such as the iterative evolutionary process 350 and the control of mechanical actuators for adjusting antenna positions. In particular embodiments, one or more computer systems 700 provide the functionalities described or illustrated herein, including optimizing antenna positions, calculating performance metrics 348, and managing communications within a wireless communication system, such as the system 300. In particular embodiments, software running on one or more computer systems 700 performs one or more steps of one or more methods described or illustrated herein or provides the functionalities described or illustrated herein, such as determining first data 322 and second data 332, and executing beamforming algorithms like the WMMSE algorithm. Particular embodiments include one or more portions of one or more computer systems 700. Herein, a reference to a computer system may encompass a computing device, for example, the computing device 302, and vice versa, where appropriate. Moreover, a reference to a computer system may encompass one or more computer systems, where appropriate.

This disclosure contemplates any suitable number of computer systems 700. This disclosure contemplates the computer system 700 taking any suitable physical form. As example and not by way of limitation, the computer system 700 may be an embedded computer system, a system-on-chip (SOC), a single-board computer system (SBC) (such as, for example, a computer-on-module (COM) or system-on-module (SOM)), a high-performance computing system for real-time optimization tasks, a desktop computer system, a laptop or notebook computer system, an industrial control system for managing antenna positioning, an interactive kiosk, a mainframe, a mesh of computer systems, a specialized processor configured for executing differential evolution algorithms, a mobile telephone, a personal digital assistant (PDA), a server, a tablet computer system, an augmented/virtual reality device, or a combination of two or more of these. Where appropriate, the computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein, such as executing the iterative evolutionary process 350 in real-time to adjust antenna positions dynamically. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 706, memory 704, storage 708, an input/output (I/O) interface 710, and a communication interface 712, interconnected by a bus 702. The computer system 700 may also include specialized hardware components such as GPUs or FPGAs to accelerate computations involved in the iterative evolutionary process 350 and beamforming algorithms. Although this disclosure describes and illustrates a particular computer system having a particular number of particular components in a particular arrangement, this disclosure contemplates any suitable computer system having any suitable number of any suitable components in any suitable arrangement.

In particular embodiments, the processor 706 includes hardware for executing instructions, such as those making up a computer program, including optimization algorithms, control processes for mechanical actuators, and signal processing tasks. As an example and not by way of limitation, to execute instructions, the processor 706 may retrieve (or fetch) the instructions from an internal register, an internal cache, memory 704, or storage 708; decode and execute the instructions; and then write one or more results to an internal register, internal cache, memory 704, or storage 708. In particular embodiments, the processor 706 may include one or more internal caches for data, instructions, or addresses. This disclosure contemplates the processor 706 including any suitable number of any suitable internal caches, where appropriate. As an example and not by way of limitation, the processor 706 may include one or more instruction caches, one or more data caches, and one or more translation lookaside buffers (TLBs). Instructions in the instruction caches may be copies of instructions in memory 704 or storage 708, and the instruction caches may speed up retrieval of those instructions by the processor 706. Data in the data caches may be copies of data in memory 704 or storage 708 that are to be operated on by computer instructions; the results of previous instructions executed by the processor 706 that are accessible to subsequent instructions or for writing to memory 704 or storage 708; or any other suitable data. The data caches may speed up read or write operations by the processor 706. The TLBs may speed up virtual-address translation for the processor 706. In particular embodiments, processor 706 may include one or more internal registers for data, instructions, or addresses. This disclosure contemplates the processor 706 including any suitable number of any suitable internal registers, where appropriate. Where appropriate, the processor 706 may include one or more arithmetic logic units (ALUs), be a multi-core processor, or include one or more processors 706, potentially arranged in parallel to handle computationally intensive tasks such as real-time optimization and signal processing. Although this disclosure describes and illustrates a particular processor, this disclosure contemplates any suitable processor.

In particular embodiments, the memory 704 includes main memory for storing instructions for the processor 706 to execute or data for processor 706 to operate on, including data structures representing antenna positions, performance metrics 348, constraints 342, and other parameters used in the iterative evolutionary process 350. As an example, and not by way of limitation, computer system 700 may load instructions from storage 708 or another source (such as another computer system 700) to the memory 704. The processor 706 may then load the instructions from the memory 704 to an internal register or internal cache. To execute the instructions, the processor 706 may retrieve the instructions from the internal register or internal cache and decode them. During or after execution of the instructions, the processor 706 may write one or more results (which may be intermediate or final results) to the internal register or internal cache. The processor 706 may then write one or more of those results to the memory 704. In particular embodiments, the processor 706 executes only instructions in one or more internal registers or internal caches or in memory 704 (as opposed to storage 708 or elsewhere) and operates only on data in one or more internal registers or internal caches or in memory 704 (as opposed to storage 708 or elsewhere). One or more memory buses (which may each include an address bus and a data bus) may couple the processor 706 to the memory 704. The bus may include one or more memory buses, as described in further detail below. In particular embodiments, one or more memory management units (MMUs) reside between the processor 706 and memory 704 and facilitate accesses to the memory 704 requested by the processor 706. In particular embodiments, the memory 704 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory implementations, this disclosure contemplates any suitable memory implementation.

In particular embodiments, the storage 708 includes mass storage for data or instructions, such as software modules implementing the iterative evolutionary process 350, control algorithms for mechanical actuators, and datasets containing historical antenna positions and performance metrics. As an example and not by way of limitation, the storage 708 may include a hard disk drive (HDD), a floppy disk drive, flash memory, an optical disc, a magneto-optical disc, magnetic tape, or a Universal Serial Bus (USB) drive or a combination of two or more of these. The storage 708 may include removable or non-removable (or fixed) media, where appropriate. The storage 708 may be internal or external to computer system 700, where appropriate. In particular embodiments, the storage 708 is non-volatile, solid-state memory. In particular embodiments, the storage 708 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 708 taking any suitable physical form. The storage 708 may include one or more storage control units facilitating communication between processor 706 and storage 708, where appropriate. Where appropriate, the storage 708 may include one or more storages 708. Although this disclosure describes and illustrates particular storage, this disclosure contemplates any suitable storage.

In particular embodiments, the I/O Interface 710 includes hardware, software, or both, providing one or more interfaces for communication between computer system 700 and one or more I/O devices, such as mechanical actuators and position sensors associated with the antennas 312. The computer system 700 may include one or more of these I/O devices, where appropriate. One or more of these I/O devices may enable communication between a person (i.e., a user) and computer system 700. As an example and not by way of limitation, an I/O device may include a keyboard, keypad, microphone, monitor, screen, display panel, mouse, printer, scanner, speaker, still camera, stylus, tablet, touch screen, trackball, video camera, position sensors like encoders or accelerometers for providing real-time position data of antennas 312, another suitable I/O device or a combination of two or more of these. An I/O device may include one or more sensors. Where appropriate, the I/O Interface 710 may include one or more device or software drivers enabling processor 706 to drive one or more of these I/O devices and to control the mechanical actuators for adjusting antenna positions. The I/O interface 710 may include one or more I/O interfaces 710, where appropriate. Although this disclosure describes and illustrates a particular I/O interface, this disclosure contemplates any suitable I/O interface or combination of I/O interfaces.

In particular embodiments, communication interface 712 includes hardware, software, or both providing one or more interfaces for communication (such as, for example, packet-based communication) between computer system 700 and one or more other computer systems 700 or one or more networks 714, including networks used by the wireless communication system 300. As an example and not by way of limitation, communication interface 712 may include a network interface controller (NIC) or network adapter for communicating with an Ethernet or any other wire-based network or a wireless NIC (WNIC) or wireless adapter for communicating with a wireless network, such as a Wi-Fi network. This disclosure contemplates any suitable network 714 and any suitable communication interface 712 for the network 714. As an example and not by way of limitation, the network 714 may include one or more of an ad hoc network, a personal area network (PAN), a local area network (LAN), a wide area network (WAN), a metropolitan area network (MAN), a cellular network, or one or more portions of the Internet or a combination of two or more of these. One or more portions of one or more of these networks may be wired or wireless. As an example, computer system 700 may communicate with a wireless PAN (WPAN) (such as, for example, a Bluetooth® WPAN), a WI-FI network, a WI-MAX network, a cellular telephone network, or any other suitable wireless network or a combination of two or more of these. Computer system 700 may include any suitable communication interface 712 for any of these networks, where appropriate. Communication interface 712 may include one or more communication interfaces 712, where appropriate. Although this disclosure describes and illustrates particular communication interface implementations, this disclosure contemplates any suitable communication interface implementation.

In particular embodiments, the bus 702 includes hardware, software, or both that communicatively couples the components of the computer system 700 to each other. As an example and not by way of limitation, the bus 702 may include an Accelerated Graphics Port (AGP) or any other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-PIN-count (LPC) bus, a memory bus, a Micro Channel Architecture (MCA) bus, a controller area network (CAN) bus for interfacing with mechanical actuators and sensors, a Peripheral Component Interconnect (PCI) bus, a PCI-Express (PCIe) bus, a serial advanced technology attachment (SATA) bus, a Video Electronics Standards Association local bus (VLB), or another suitable bus or a combination of two or more of these buses. The bus 702 may include one or more buses, where appropriate. Although this disclosure describes and illustrates a particular bus, this disclosure contemplates any suitable bus or interconnect.

Herein, a computer-readable non-transitory storage medium or media may include one or more semiconductor-based or other types of integrated circuits (ICs), such as FPGAs or ASICs configured to accelerate computations related to the iterative evolutionary process 350 and signal processing tasks, hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

All of the disclosed methods and procedures described in this disclosure can be implemented using one or more computer programs or components. These components may be provided as a series of computer instructions on any conventional computer readable medium or machine readable medium, including volatile and non-volatile memory, such as RAM, ROM, flash memory, magnetic or optical disks, optical memory, or other storage media. The instructions may be provided as software or firmware, and may be implemented in whole or in part in hardware components such as ASICs, FPGAs, DSPs, or any other similar devices. The instructions may be configured to be executed by one or more processors, which when executing the series of computer instructions, performs or facilitates the performance of all or part of the disclosed methods and procedures.

It should be understood that various changes and modifications to the examples described here will be apparent to those skilled in the art. Such changes and modifications can be made without departing from the spirit and scope of the present subject matter and without diminishing its intended advantages. It is therefore intended that such changes and modifications be covered by the appended claims.

1. A method comprising:
determining first data corresponding to at least a subset of a plurality of antennas in a wireless communication system, wherein the first data comprises separate position data corresponding to each of at least the subset of the plurality of antennas;
determining, based on the first data, second data corresponding to target positions for at least the subset of the plurality of antennas, wherein the second data comprises target positions for at least the subset of the plurality of antennas during an operational period of the wireless communication system, and wherein determining the second data comprises applying an iterative evolutionary process to the first data to determine the target positions for at least the subset of the plurality of antennas; and
adjusting the physical positions of at least the subset of the plurality of antennas based on the target positions for at least the subset of the plurality of antennas.

2. The method of claim 1, wherein applying the iterative evolutionary process comprises representing each of the separate position data corresponding to each of at least the subset of the plurality of antennas as an individual within the iterative evolutionary process.

3. The method of claim 2, wherein the iterative evolutionary process comprises a differential evolution process.

4. The method of claim 3, wherein the differential evolution process includes independently evolving each individual through mutation operations, crossover operations, selection operations, or a combination thereof.

5. The method of claim 4, wherein the mutation operations comprise, for each antenna, generating modified position data by combining position data of randomly selected individuals.

6. The method of claim 4, wherein the crossover operations comprise, for each antenna, recombining the modified position data with the corresponding current position data to produce trial position data.

7. The method of claim 4, wherein the selection operations comprise selecting, for each antenna, between the trial position data and the current position data based on a first measure.

8. The method of claim 7, wherein the first measure comprises determining a second measure based on the severity of constraint violations.

9. The method of claim 8, wherein the constraints comprise at least one of:
minimum inter-antenna spacing requirements to avoid coupling effects;
boundary conditions confining antenna movement within a designated spatial region; or
a combination thereof.

10. The method of claim 9, wherein determining the second measure comprises:
determining a measure of constraint violation by calculating a difference between actual antenna positions and positions satisfying the constraints; and
determining the second measure based on the degree of constraint violation; and
further comprising determining the first measure based on the second measure.

11. The method of claim 10, wherein the second measure increases proportionally with the extent to which the constraints are violated.

12. The method of claim 1, wherein determining the second data comprises applying the iterative evolutionary process to enhance a communication performance metric of the wireless communication system.

13. The method of claim 1, wherein the plurality of antennas are movable antennas configured to adjust positions within a predefined movable region during operation of the wireless communication system.

14. The method of claim 13, wherein adjusting the physical positions comprises moving each antenna within the predefined movable region to the corresponding target position specified in the second data.

15. The method of claim 1, wherein the iterative evolutionary process is performed in real-time during operation of the wireless communication system.

16. The method of claim 1, wherein the iterative evolutionary process comprises:
alternating between a collective representation and an individual representation of the position data to balance exploration and exploitation in determining the target positions.

17. The method of claim 16, wherein:
the collective representation treats all position data collectively as a single individual within the iterative evolutionary process during exploration phases;
the individual representation treats each of the separate position data as an individual within the iterative evolutionary process during exploitation phases; or
a combination thereof.

18. A system comprising:
a processor; and
a memory storing instructions which, when executed by the processor, cause the processor to perform operations including:
determining first data corresponding to at least a subset of a plurality of antennas in a wireless communication system, wherein the first data comprises separate position data corresponding to each of at least the subset of the plurality of antennas;
determining, based on the first data, second data corresponding to target positions for at least the subset of the plurality of antennas, wherein the second data comprises target positions for at least the subset of the plurality of antennas during an operational period of the wireless communication system, and wherein determining the second data comprises applying an iterative evolutionary process to the first data to determine the target positions for at least the subset of the plurality of antennas; and
adjusting the physical positions of at least the subset of the plurality of antennas based on the target positions for at least the subset of the plurality of antennas.

19. The system of claim 18, wherein the iterative evolutionary process comprises a differential evolution process.

20. A non-transitory, computer-readable medium storing instructions which, when executed by a processor, cause the processor to perform operations comprising:
determining first data corresponding to at least a subset of a plurality of antennas in a wireless communication system, wherein the first data comprises separate position data corresponding to each of at least the subset of the plurality of antennas;
determining, based on the first data, second data corresponding to target positions for at least the subset of the plurality of antennas, wherein the second data comprises target positions for at least the subset of the plurality of antennas during an operational period of the wireless communication system, and wherein determining the second data comprises applying an iterative evolutionary process to the first data to determine the target positions for at least the subset of the plurality of antennas; and
adjusting the physical positions of at least the subset of the plurality of antennas based on the target positions for at least the subset of the plurality of antennas.
